(19) United States
(12) Patent Application Publication
(10) Pub. No.: US 2022/0215138 A1
(43) Pub. Date: Jul. 7, 2022

(54) Method for Validating System Parameters of an Energy System, Method for Operating an Energy System, and Energy Management System for an Energy System

(71) Applicant: Siemens Aktiengesellschaft, München (DE)

(72) Inventors: Arvid Amthor, Grabfeld OT Nordheim (DE); Oliver Dölle, Erlangen (DE)

(73) Assignee: Siemens Aktiengesellschaft, München (DE)

(21) Appl. No.: 17/610,612

(22) PCT Filed: Apr. 2, 2020
(86) PCT No.: PCT/EP2020/059360

§ 371 Date: Nov. 11, 2021

(30) Foreign Application Priority Data
May 15, 2019 (DE) 10 2019 207 059.0

(51) Int. Cl. G06F 30/20; G06F 17/18

(52) U.S. Cl. CPC G06F 30/20; G06F 2119/02; G06F 17/18

(57) ABSTRACT

Various embodiments include a computer-aided method for validating system parameters ascertained by measurement data and serving for a model function η of a component of an energy system, wherein the model function η characterizes a dependence of an output variable of the component on an input variable of the component taking into account the system parameters. The methods include: calculating a standard deviation of the system parameters; calculating a confidence bound based at least in part on the calculated standard deviation; and defining the system parameters as valid if the ratio of confidence bound to the model function is less than or equal to a defined threshold within a value range defined for the input variable.

### CROSS-REFERENCE TO RELATED APPLICATIONS

This application is a U.S. National Stage Application of International Application No. PCT/EP2020/059360 filed Apr. 2, 2020, which designates the United States of America, and claims priority to DE Application No. 10 2019 207 059.0 filed May 15, 2019, the contents of which are hereby incorporated by reference in their entirety.

### TECHNICAL FIELD

The present disclosure relates to energy systems. Various embodiments include methods for operating an energy system and/or energy management systems.

### BACKGROUND

An efficient coordination of energy conversion, energy storage and/or energy use, in particular within multimodal and/or decentralized energy systems, is typically no longer possible on the basis of a heuristic operating method. Accordingly, a transition to model-based open-loop or closed-loop control approaches may be advantageous. However, model-based operating methods require the components of the energy system (system components) and the behavior thereof to be characterized or mapped by means of mathematical models, that is to say by means of a model function.

Typically, a plurality of system parameters which parameterize the model function of the component are required to model a component of the energy system. These system parameters must be determined as accurately as possible so that the model function describes or maps the actual or real operation of the component to the best possible extent. The system parameters are typically captured manually, that is to say offline. However, the outlay increases significantly as a result of this manual identification of the system parameters (parameter identification), and so consequently the costs increase significantly, particularly when putting the component into operation. Moreover, manual parameter identifications have an increased susceptibility to errors in comparison with automated parameter identification, that is to say online parameter identification.

In computer-aided automated identification of system parameters, measurement values of input variables are typically captured in advance over a defined value range of the input variables. In a first step of automated parameter identification, the latter are prepared to form a measurement data record. In a second step of automated parameter identification, the system parameters are identified by means of the prepared measurement values, that is to say by means of the measurement data record. The identified system parameters are validated in a third step of automated parameter identification. The validation of the system parameters (assessment of the quality of the identified system parameters) is required to ensure the correctness of the system parameters and hence the correctness of the model.

In known parameter identifications, the validation is implemented by comparing the model to measurement data, this comparison being carried out by means of the root mean squared error (RMSE). This method is known from offline parameter identification in particular and, in that case, typically combined with a graphical evaluation by the user or a targeted or individual stipulation of input variables by way of test operations. However, this known validation does not ensure a robust validation of the identified system parameters in all relevant cases, particularly during running operation of the component or the energy system.

In particular, it is problematic that the measurement values of the input variables are not typically available over the entire working range of the component and/or the measurement values or measurement data have a multicollinearity. Expressed differently, the measurement values of the input variables are captured within a value range which typically does not correspond to the entire possible working range of the component or of the energy system. As a result, the RMSE can be minimized sufficiently in the range of the captured measurement values (value range) but the RMSE can be significantly increased outside of this value range and still within the working range of the component. However, this increase is not recognizable using known validations.

Expressed differently, the RMSE depends on the range of the input variables (value range) considered, for which measurement values of the input variables were captured or which is covered by the measurement values of the input variable or which is covered by the measurement data record. Accordingly, a robust validation of the system parameters is not possible in the case of known automated parameter identifications using known metrics (RMSE and/or CVRMSE). In practice, this effect is additionally amplified in the case of complex models with a relatively large number of system parameters and/or a plurality of influencing variables. For exogenous influencing variables in particular, there is typically no direct control access to the individual exogenous influencing variables, and so these cannot be excited in targeted fashion and thus captured.

Cross validation is a further known method used to validate the system parameters. In this case, the captured measurement data are divided into training data and test data. However, errors in the estimation of the system parameters (parameter identification) are likewise not identifiable in this method if the captured measurement data have multicollinearity and/or comparable working points. Consequently, an exact and reliable validation of the system parameters is decisive for efficient operation of the energy system, particularly within the scope of closed-loop model-predictive control.

### SUMMARY

The present invention is based on the object of providing an improved method for validating system parameters of at least one component of an energy system. For example, some embodiments of the teachings herein include a computer-aided method for validating system parameters (41) which have been ascertained by means of measurement data and which serve for a model function η (10) of at least one component of an energy system, wherein the model function η (10) characterizes at least one dependence of at least one output variable of the component on at least one input variable of the component taking into account the system parameters (41), characterized by the steps of: calculating a standard deviation of the system parameters (41) ascertained from the measurement data; calculating a confidence bound ψ (42) on the basis of the calculated standard deviation; and defining the system parameters (41) as valid if the ratio of confidence bound ψ (42) to model function η (10) is less than or equal to a defined threshold δ within a value range (22) that has been defined for the input variable.

In some embodiments, the value range (22) is defined to be smaller than a working range (24) of the component.

In some embodiments, the standard deviation is calculated by means of a covariance matrix Σ_{θ} of the system parameters (41) that were ascertained from the measurement data.

In some embodiments, the covariance matrix is calculated by means of Σ_{θ}=E[(θ−E(θ))·(θ−E(θ))^{T}], where θ denotes the vector of the system parameters (41) and E denotes the expected value.

In some embodiments, the standard deviation is calculated by means of σ₇₂=\sqrt{(∇_{θ}η)^{T}·Σ_{θ}·∇_{θ}η}.

In some embodiments, the confidence bound (42) is calculated by means of the product of a value of the Student's t-distribution and the standard deviation.

In some embodiments, the confidence bound (42) is calculated by means of ψ=K·t_{1-α/2}·σ_{η}, where t_{1-α/2} denotes the value of the Student's t-distribution at a significance level α and K is a constant greater than zero.

In some embodiments, the system parameters (41) are defined as valid if ψ/η≤δ.

In some embodiments, the threshold δ is set between 0 and 0.1.

In some embodiments, constraints of the system parameters (41) and/or constraints of the model function (10) are taken into account for the purposes of validating the system parameters (41).

As another example, some embodiments include a method for operating an energy system in which the energy system is controlled at least in part by means of a closed-loop model-predictive control on the basis of at least one model function (10) of at least one component of the energy system, characterized in that the system parameter (41) of the model function (10) on which the closed-loop model-predictive control is based is defined to be valid for the closed-loop control by means of a method as claimed in any one of the preceding claims.

In some embodiments, the system parameters (41) are ascertained from measurement data of the energy system.

In some embodiments, the measurement data are ascertained in automated fashion on the basis of captured measurement values (40).

In some embodiments, the measurement values (40) are prepared, in particular filtered, for the purposes of ascertaining the measurement data.

As another example, some embodiments include an energy management system for an energy system, comprising a measuring unit and a computing unit, wherein a plurality of measurement values (40) in respect of system parameters (41) of the at least one component of the energy system are able to be captured and associated measurement data are able to be provided by means of the measuring unit, characterized in that the computing unit is designed to carry out a method as claimed in any one of the preceding claims.

### BRIEF DESCRIPTION OF THE DRAWINGS

Further advantages, features, and details of the invention will become apparent from the exemplary embodiments described below and with reference to the drawings, in which:

FIG. 1 shows a flowchart of an automated parameter identification incorporating teachings of the present disclosure; and

FIG. 2 shows a diagram for elucidating a confidence bound or confidence interval using the example of an input variable.

Identical, equivalent, and/or functionally identical elements may be provided with the same reference signs in one of the figures or throughout the figures.

### DETAILED DESCRIPTION

The present disclosure describes computer-aided methods for validating system parameters which have been ascertained by means of measurement data and which serve for a model function η at least one component of an energy system, wherein the model function η characterizes at least one dependence of at least one output variable of the component on at least one input variable of the component taking into account the system parameters, is characterized at least by the following steps:
calculating a standard deviation of the system parameters ascertained from the measurement data;
calculating a confidence bound ψ on the basis of the calculated standard deviation; and
defining the system parameters as valid if the ratio of confidence bound ψ to model function η is less than or equal to a defined threshold δ within a value range that has been defined for the input variable.

In some embodiments, the validation of the system parameters is implemented by means of a confidence bound. This may improve the validation of the system parameters such that the energy system in particular can be improved or operated more efficiently, for example on the basis of a closed-loop model-predictive control which comprises a method as described herein. In some embodiments, the confidence bound is calculated on the basis of the standard deviation of the system parameters. The system parameters or their ascertained mean values are provided for parameterizing the model function.

The model function typically depends on a plurality of input variables and a plurality of system parameters and has one or more output variables. The input variables, the output variables, and the system parameters can be respectively combined to form a vector, which is denoted in bold in the present case. Expressed differently, the model is characterized by Y=η(θ,X) for example, where X denotes the input variables, Y denotes the output variables, θ denotes the system parameters and η denotes the model function.

The input variables can still be subdivided into exogenous and endogenous input variables. A typical model function is the efficiency and/or the coefficient of performance of the component, for example of an energy conversion system. In this case, the component receives input energy flows pⁱⁿ and converts these into output energy flows p^{out}. This energy conversion may depend on the exogenous input variables v and the system parameters θ. Expressed differently, p^{out}=η(θ,v,pⁱⁿ) or for example p^{out}=η(θ,v)·pⁱⁿ may hold true, where η(θ,v) denotes the matrix of the efficiencies and/or coefficients of performance for conversions of an energy flow pᵢⁱⁿ entering the component into an energy flow pⱼ^{out} exiting the component. Expressed differently, pᵢ^{out}=Σⱼ(η(θ,v))ᵢⱼ·pⱼⁱⁿ.

Within the scope of the present disclosure, the term efficiency refers to coefficients of performance.

Examples of energy conversion systems include heat pumps, refrigeration machines, diesel generators, combined heat and power plants, photovoltaic systems, wind power systems, biogas systems, waste incineration systems, and/or sensors, and/or other components.

In some embodiments, the system parameters are typically ascertained by means of a measurement data record. Expressed differently, the method according to the invention can be a partial step of an automated parameter identification.

Measurement values, in particular in respect of the input variable, which are typically captured in advance are prepared, in particular filtered, in a first step of the automated parameter identification. This provides a measurement data record, in particular a training data record. However, the measurement data may have likewise been generated and provided synthetically, for example by means of a simulation and/or a prediction, within the scope of the present disclosure. Consequently, the measurement data need not necessarily be based on actually captured measurement values; instead, they may, at least in part, in particular in full, have been produced synthetically. The measurement data may be available for a training data range which, in particular, is smaller than or equal to the value range of the input variable. Expressed differently, the measurement data can be divided into training data and further measurement data (test data), wherein the training data are used to ascertain the system parameters. Consequently, the measurement data can be, or at least comprise, the training data.

The system parameters are identified, that is to say ascertained, on the basis of the measurement data in a second step of the automated parameter identification. This can be implemented by means of a general model approach y=f(θ,x)+ε, wherein the variables x,y need not necessarily correspond to the real input variables and output variables. Expressed differently, a suitable reformulation of the model from Y=η(θ,X)+ε to y=f(θ,x)+ε can simplify, for example linearize, the ascertainment of the system parameters. In this case, ε denotes the respective model error which is typically minimized where possible for the purposes of identifying and/or ascertaining the system parameters.

In some embodiments, a method includes a third step of an automated parameter identification, that is to say a validation of the system parameters ascertained from the measurement data. Expressed differently, the third step of an automated parameter identification may comprise a validation method as described herein. The system parameters may be ascertained statistically on the basis of the measurement data by way of the described procedure during the automated parameter identification. Consequently, the system parameters have a standard deviation as a matter of principle, which standard deviation is calculated or ascertained or determined in a first step of the method according to the invention. In this case, the standard deviation quantifies at least the variation of the ascertained system parameters in respect of an actual and/or simulated operation of the component or of the energy system.

The confidence bound is calculated or ascertained or determined on the basis of the calculated standard deviation in a second step of the method according to the invention for validating the system parameters.

Basically, it is possible to define a confidence interval by means of the confidence bound ψ. A confidence interval typically has a lower and an upper confidence bound. The upper and lower confidence bound can be the same in terms of magnitude so that the confidence interval has a width of 2ψ. Consequently, the confidence interval of the model function is defined by [72 (θ,X) −ψ(θ,X),η(θ,X)+ψ(θ,X)], for example. If the model function is, in particular, the efficiency of the component, which depends on the system parameters θ, the exogenous input variables v and the input energy flows pᵢₙ, that is to say if p^{out}=η(θ,v,pⁱⁿ) applies, the confidence interval can be rendered more precisely as [η(θ,v,pⁱⁿ)−ψ(θ,v,pⁱⁿ),η(θ,v, pⁱⁿ)+ψ(θ,v,pⁱⁿ)]. In principle, the confidence bound therefore likewise is a function of the system parameters, of the endogenous and/or exogenous input variables and/or the variances and covariances of the system parameters.

The confidence interval or the confidence bound corresponds to the information content of the measurement data for the model function. Accordingly, the confidence bound or the confidence interval is ever smaller in terms of the absolute value, the greater the variance of the input variables, in particular of the exogenous input variables. Furthermore, the confidence bound and/or the confidence interval is ever smaller in terms of absolute value, the better the fit in respect of the parameter identification (regression), the smaller the correlations between the input variables, and/or the greater the distance between the value of v or pⁱⁿ and the mean value of the training data, and/or the greater the number of training data available.

The system parameters are defined as valid in a third step of the methods if the ratio of the calculated confidence bound to the model function is less than or equal to the defined threshold within the value range that has been defined for the input variable. Expressed differently, the relative uncertainty in respect of the system parameters is defined by the ratio and the threshold. The threshold can be defined depending to the required reliability or accuracy. Consequently, the threshold corresponds to a maximum relative uncertainty which the system parameters may exhibit. It should be noted here that the ratio of confidence bound and model function likewise is a function in respect of the input variables. By way of example, the ratio is formed by ψ(θ,v,pᵢₙ)/η(θ,v,pᵢₙ), and is consequently likewise a function of the endogenous and/or exogenous input variables and of the system parameters. The system parameters are valid in this case if ψ(θ,v,pᵢₙ)/η(θ,v,pᵢₙ)<δ or equivalently ψ(θ,v,pᵢₙ)<δ. η(θ,v,pᵢₙ). Furthermore, all reformulations mathematically equivalent to the inequality ψ(θ,v,pᵢₙ)/η(θ,v,pᵢₙ)<δ are likewise included in the scope of the present disclosure.

The teachings of the present disclosure consequently provide a validation of the system parameters on the basis of the relative uncertainty of said system parameters. In this case, the relative uncertainty may be based on statistical considerations, substantially on the confidence bound or the ratio of the confidence bound to the model function in the present case. In principle, the uncertainty about the actually present system parameters or the values thereof becomes greater as the absolute value of the confidence bound increases. Expressed differently, what typically applies is that the broader the confidence interval, the greater the uncertainty about the system parameters actually present. Then, the required or desired accuracy/reliability can be defined by way of the threshold. The smaller the threshold, the smaller the uncertainty and the greater the accuracy/reliability in respect of the system parameters.

The teachings of the present disclosure consequently facilitate a robust estimate about the quality of the model over the whole or entire working range of the component, even if measurement data are not available over this entire working range. Expressed differently, the teachings facilitate a meaningful and statistically robust extrapolation from the value range of the input variables defined for identifying the system parameters or from the considered value range of the input variables to the whole or entire working range of the component.

Furthermore, required specifications, for example limits of the working range, limits for the width of the confidence interval and limits for the efficiency, as used in the present disclosure, can be interpreted easily from a physical point of view. This may be advantageous when assessing the quality of gray box models and/or black box models since a physical interpretation of the individual identified system parameters is typically difficult or not possible in these cases.

In some embodiments, a method for operating an energy system is controlled at least in part by means of a closed-loop model-predictive control on the basis of at least one model function of at least one component of the energy system. The methods for operating an energy system may be characterized in that the system parameter of the model function on which the closed-loop model-predictive control is based is defined as valid for the closed-loop control by means of a validation method according to the present invention and/or one of the configurations thereof.

In some embodiments, the closed-loop model-predictive control is based on the value range of the input variable that is typically smaller than the working range of the component. As a result, it is possible to extrapolate the confidence interval or the model function to the working range. Should this even be possible, it is not necessary to take account of the working range as a result of the use according to the invention of the confidence bound or the confidence interval.

Although the system parameters are only identified by means of the values of the input variables within the value range, said system parameters can be extrapolated in statistically quantifiable manner to the larger working range on account of the validation taught herein. Expressed differently, it is possible to ascertain whether the model or the closed-loop model-predictive control is likewise valid for regions outside of the value range or value ranges taken into account for the ascertainment of the system parameters. Advantages and configurations of the methods described herein for operating the energy system arise, which are similar and equivalent to those of the validation methods.

The energy management systems taught herein for an energy system comprises a measuring unit and a computing unit, wherein a plurality of measurement values in respect of system parameters of at least one component of the energy system are able to be captured and the associated measurement data are able to be provided by means of the measuring unit. In some embodiments, the computing unit is designed to carry out a method as claimed in any one of the preceding claims. In particular, the computing unit comprises a computer, a quantum computer, a server, a cloud server and/or any other distributed network and/or computing systems.

In some embodiments, the value range is defined to be smaller than a working range of the component. Typically, the working range of the component in respect of the input variable is characterized by the values of the input variable which the input variable adopts or can adopt during the operation of the component. The value range which is used for the validation may be smaller. By way of example, the result of a simulation or prediction is that the temperature will be between 5 degrees Celsius and 10 degrees Celsius in the coming two weeks. In some embodiments, the range between 5 degrees Celsius and 10 degrees Celsius is now used as a value range for the temperature (exogenous input variable). However, the component may be designed for a working range from −10 degrees Celsius to 30 degrees Celsius, and so the value range used for the validation is smaller. This can significantly shorten the identification time for the system parameters. Furthermore, the time until the model or the system parameters is/are identified as valid may be likewise shortened.

In some embodiments, the standard deviation is calculated by means of a covariance matrix Σ_{θ} of the system parameters that were ascertained from the measurement data. Correlations between the individual system parameters may be taken into account as a result thereof. The covariance matrix corresponds to the reciprocal of the Fisher information matrix, and so the latter allows direct conclusions to be drawn about the information content of the measurement data. Expressed differently, the information content of the measurement data or the measurement values may be taken into account during the validation, in contrast to known methods such as RMSE and/or CVRMSE, for example.

In some embodiments, the covariance matrix may be calculated by means of Σ₇₄=E[(θ−E(θ))·(θ−E(θ))^{T}], where θ denotes the vector of the system parameters and E denotes the expected value. In some embodiments, the variances and correlations or covariances between the system parameters are calculated and represented by means of a common matrix as a result. Thus, the following applies to the covariance matrix or its components: (Σ_{θ})ᵢⱼ=Cov(θᵢ,θⱼ) for i≠j and (Σ_{θ})ᵢᵢ=Var(θᵢ), for respectively i,j=1, . . . , n and θ=(θ₁, . . . , θₙ)^{T}.

If the system parameters are identified by means of the least-squares method (second step of the automated parameter identification) and if homoscedasticity and no autocorrelation are present for the model error ε, then Σ_{θ}=σ²(θ^{T} θ)⁻¹, for example, where σ denotes the standard deviation and σ² denotes the variance. In this case, the population variance σ² is estimated by means of the model error ε and the number of measurement points k from the existing sample using σ²=ε^{T}ε/(k−n). In the literature, estimators or estimation functions, for example for the system parameters, variances and/or covariance, are also labeled by a hat, and so it is also possible to write \hat{σ}²=\hat{ε}^{T}\hat{ε}/(k−n), for example.

In some embodiments, the standard deviation is calculated by means of σ_{η}=\sqrt{(∇_{θ}η)^{T}·Σ_{θ}·∇_{θ}η}, where η denotes the model function. In some embodiments, this improves the validation of the system parameters. This is the case because the standard deviation is calculated with the methods of error propagation as a result thereof. If the model function is the efficiency, then σ_{η}=σ_{η}(θ,v,pᵢₙ)={square root over ((∇_{θ}η(θ,v,pᵢₙ))^{T}·Σ_{θ}·∇_{θ}η(θ,v,pᵢₙ))}. In this case, ∇_{θ}η denotes the gradient of the model function if measurement uncertainties in respect of the system parameters θ are neglected. Expressed differently, ∇_{θ}η=(∂_{θ}_{₁}η, . . . , ∂_{θ}_{ₙ}η)^{T}, where ∂_{θ}_{ᵢ}η denotes the partial derivative of the model function with respect to the system parameter θᵢ.

In some embodiments, the confidence bound is calculated by means of the product of a value of the Student's t-distribution and the standard deviation.

In some embodiments, the confidence bound is calculated by means of ψ=K·t_{1-α/2}·σ_{η} in this case, where t_{1-α/2} denotes the value of the Student's t-distribution at a significance level α and K is a constant greater than zero. In some embodiments, K=1 holds true, and so ψ=t_{1-α/2}·σ_{η}, where α denotes the significance level and (1−α) denotes the confidence level taking into account the degree of freedom (k−n) present. By way of example (1−α)=0.95, that is to say 95 percent. Consequently, the corresponding confidence interval may be set by [η(θ,v,pᵢₙ)−t_{1-α/2}·σ_{η}(θ,v,pᵢₙ),η(θ,v,pᵢₙ)+t_{1-α/2}·σ_{η}(θ,v,pᵢₙ)].

In some embodiments, the system parameters are defined as valid if ψ/η≤δ, where δ denotes the defined threshold. It should be noted here that the ratio ψ/η is a function of the input variables X, and so the system parameters θ are defined as valid if ψ(θ,X)/η(θ,X)<δ. The confidence bound ψ is preferably ascertained or calculated using the Student's t-distribution and the model function corresponds to the efficiency and/or the coefficient of performance of the component such that the system parameters are defined as valid in this case if ψ(θ,v,pᵢₙ,t_{1-α/2})/η(θ,v,pᵢₙ)<δ or ψ(θ,v,pᵢₙ,t_{1-α/2})<δ·η(θ,v,pᵢₙ).

In some embodiments, the less than sign in ψ(θ,v,pᵢₙ,t_{1-α/2})<δ·η(θ,v,pᵢₙ) can be replaced by the less than or equal sign, that is to say the system parameters are valid if ψ(θ,v,pᵢₙ,t_{1-α/2})≤δ·η(θ,v,pᵢₙ). The two formulations are equivalent within the meaning of the present disclosure. The confidence bound likewise depends on the significance level α. By way of example, the threshold δ and the significance level are defined in such a way that the width of the 95 percent confidence interval is only 15 percent of the efficiency present at the working point in each case.

In some embodiments, the threshold δ is set between 0 and 0.1. Expressed differently, δϵ[0,0.1]. This may improve the validation of the system parameters. In some embodiments, constraints of the system parameters and/or constraints of the model function are taken into account for the purposes of validating the system parameters.

In some embodiments—in contrast to so-called black box models—the efficiencies and/or optionally the system parameters can be checked or tested for plausibility. One such constraint for the efficiency (model function) is that, for example, the latter is below the Carnot efficiency theoretically possible for the process. Further plausibility tests can be provided; in particular, it is possible to define positive and negative limits for the individual components of the energy system, which the efficiency and/or the confidence interval must not exceed over the complete working range of all input variables. Thus, identified system parameters should not be used if the efficiency adopts a value of less than zero at certain working points, for example. Such constraints may likewise arise from the technical datasheet of the component.

In some embodiments, the system parameters are ascertained from measurement data, in particular training data, of the energy system. In this case, the measurement data are preferably ascertained in automated fashion on the basis of the captured measurement values. As an alternative or in addition thereto, the measurement data are generated and provided synthetically, for example by means of a simulation and/or a prediction. Overall, this provides an automated parameter identification. In some embodiments, the measurement values to be prepared, in particular filtered, for the purposes of ascertaining the measurement data. In particular, these are divided into training data and further measurement data.

In some embodiments, this improves the accuracy of the ascertainment of the system parameters and the validation thereof. Overall, this improves the automated parameter identification and the closed-loop model-predictive control.

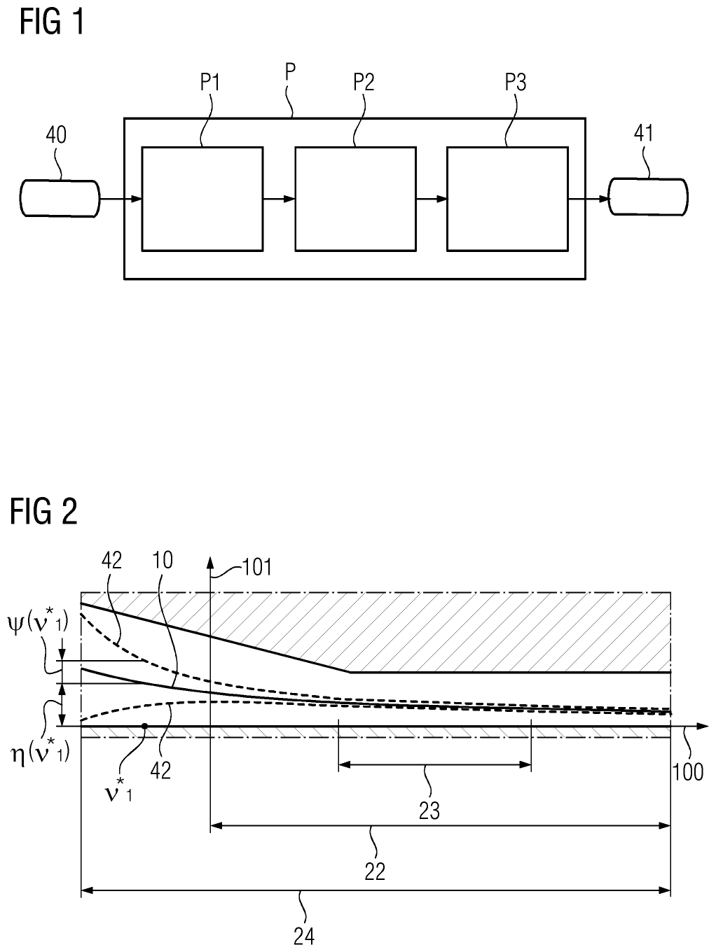

FIG. 1 shows a parameter identification P incorporating teachings of the present disclosure, which comprises a computer-aided method according for validating system parameters as a step or as a partial step. The parameter identification P can be part of a closed-loop model-predictive control of an energy system such that, in this respect, it is likewise possible to talk about a validation of the model which is substantially represented by a model function.

Consequently, the energy system is for example controlled at least in part, in particular in terms of at least one of its components, by means of a closed-loop model-predictive control, wherein the model function which typically has a plurality of system parameters is provided for closed-loop control. Expressed differently, a parameterization of the model is required, that is to say the values or the system parameters need to be identified and/or determined and/or ascertained so that it is possible to use the model for the closed-loop control of the energy system or its operation.

Furthermore, the model function depends on one or more input variables, for example an electrical and/or thermal power/energy, and quantifies the dependence of one or more output variables of the component, for example an electrical and/or thermal power/energy, on the basis of the input variables. The system parameters parameterize this dependence. In particular, a temperature, for example an external temperature, a pressure, a wind speed, and/or further physical variables are exogenous input variables. The system parameters parameterize the model function. Typically, these occur in the model function together with one of the input variables, for example in the form of a product of system parameters and input variable. Typically, the system parameters have no direct physical interpretation. However, these may correspond for example to thermal losses (heat losses) and/or thermal resistances. By way of example, p^{out}=η(θ,v)·pⁱⁿ with η(θ,v)=θ₁T_{ambient}+θ₂(v²−2p/p)+θ₃pⁱⁿ, where v denotes a wind speed, p denotes a pressure, ρ denotes a density and T_{ambient} denotes an external temperature.

The automated parameter identification P comprises a first step P1, a second step P2 and a third step P3. Captured and/or synthetically generated measurement values 40, for example the temperature of a component of the energy system, are prepared, in particular filtered, to form a measurement data record in a first step P1.

The system parameters 41 of the model or of the model function are identified in the second step P2 by means of the measurement data record ascertained in the first step P1. The system parameters 41 identified in the second step P2 are validated in the third step P3.

In accordance with the illustrated configuration shown, the validation is implemented by means of a validation method (method of validation). Expressed differently, the identified system parameters 41 are analyzed in respect of their information content. In some embodiments, this is facilitated by calculating and using the confidence bound or the confidence interval. In some embodiments, this allows the identification, determination and/or ascertainment of the system parameters 41 to be implemented over a relatively small value range of the input variables, but nevertheless allows a statement to be made about the validity of the system parameters 41 over a working range of the component which is typically significantly larger. This improves the closed-loop control of the component or of the energy system, in particular within the entire working range of the component.

The system parameters 41 identified as valid are subsequently used for the closed-loop model-predictive control.

FIG. 2 shows a diagram for elucidating a confidence bound or confidence interval for an input variable. The input variable, for example an exogenous input variable v, is plotted in arbitrary units along the abscissa 100 of the illustrated diagram. The model function η, in particular the efficiency and/or the coefficient of performance of the component, is plotted in arbitrary units along the ordinate 101 of the diagram.

The functional dependence of the model function, in particular of the efficiency, on the input variable is illustrated by the curve 10. Consequently, the model function is likewise labeled by the reference sign 10.

The input variable has a minimum and maximum value, which form the limits of a working range 24 of the component. Expressed differently, the input variable adopts the values within the working range 24 during the operation of the component.

In the case of an automated parameter identification, within the scope of which system parameters for parameterizing the model function 10 are identified and/or ascertained and/or determined, the system parameters are identified or ascertained or determined over a defined value range 22 of the input variable. In some embodiments, the measurement data of the input variable are available within a training data range 23 and not within the defined value range 22, with the value range 22 being less than the entire working range 24 of the component. In this sense the system parameters are determined locally and it is questionable as a matter of principle whether the system parameters determined locally in respect of the values of the input variable can be extrapolated over the entire possible value range of the input variable (working range 24).

By way of example, the input variable is an ambient temperature (or external temperature) of the component. Should it be known that the ambient temperature in the coming two weeks will lie in the range from 10 degrees Celsius to 25 degrees Celsius and/or if measurement data synthetically generated by means of a prediction are only available for this temperature range, the system parameters of the model function of the component have only been defined within this temperature range. It is therefore questionable whether the model parameterized on the basis of this value range, that is to say the system parameters, are valid for a temperature outside of the specified temperature range, for example for an ambient temperature ranging from 0 degrees Celsius to 5 degrees Celsius, which may randomly occur during the operation of the component. The method of validation by means of RSME known from the prior art is not able to solve this technical problem.

In some embodiments, the methods and systems address the aforementioned technical problem by means of a confidence bound that is calculated as taught herein. In FIG. 2, the confidence bound 42 or the confidence interval is represented by the two curves delimiting the model function 10. It is evident that the confidence bounds 42 (upper and lower confidence bound 42) or the confidence interval become/becomes larger outside of the value range 22 of the input variable. This reflects the uncertainty of the system parameters or of the parameterized model outside of the value range 22 that was used to ascertain the system parameters.

According to the present case, the system parameters are identified as valid if the ratio of confidence bound 42 to model function 10 is less than or equal to a defined threshold within the value range 22 that has been defined for the input variable. As a result, a sufficient reliability for the model can be attained outside of the value range 22 and for the working range 24 of the component.

Although the teachings herein have been described and illustrated in more detail by way of the preferred exemplary embodiments, the scope of the teachings is not restricted by the disclosed examples or other variations may be derived therefrom by a person skilled in the art without departing from the scope of protection of the disclosure.

### LIST OF REFERENCE DESIGNATIONS

P Parameter identification

P1 First step of parameter identification

P2 Second step of parameter identification

P3 Third step of parameter identification

10 Model function

22 Value range

23 Training data range

24 Working range

40 Measurement values

41 System parameters

42 Confidence bound

100 Abscissa

101 Ordinate

What is claimed is:

1. A computer-aided method for validating system parameters ascertained by measurement data and serving for a model function η of a component of an energy system, wherein the model function η characterizes a dependence of an output variable of the component on an input variable of the component taking into account the system parameters, the method comprising:
calculating a standard deviation of the system parameters;
calculating a confidence bound based at least in part on the calculated standard deviation; and
defining the system parameters as valid if the ratio of confidence bound to the model function is less than or equal to a defined threshold within a value range defined for the input variable.

2. The computer-aided method as claimed in claim 1, wherein the value range is smaller than a working range of the component.

3. The computer-aided method as claimed in claim 1, wherein the standard deviation is calculated using a covariance matrix Σ_{θ} of the system parameters.

4. The computer-aided method as claimed in claim 3, wherein the covariance matrix is calculated using Σ_{θ}=E[(θ−E(θ))·(θ−E(θ))^{T}], where θ denotes the vector of the system parameters (41) and E denotes the expected value.

5. The computer-aided method as claimed in claim 1, wherein the standard deviation is calculated by means of σ_{η}=\sqrt{(∇_{θ}η)^{T}·Σ_{θ}·∇_{θ}η}.

6. The computer-aided method as claimed in claim 1, wherein the confidence bound is calculated using a product of a value of the Student's t-distribution and the standard deviation.

7. The computer-aided method as claimed in claim 6, wherein the confidence bound is calculated using ψ=K·t_{1-α/2}·σ_{η}, where t_{1-α/2} denotes the value of the Student's t-distribution at a significance level α and K is a constant greater than zero.

8. The computer-aided method as claimed in claim 1, wherein the system parameters (41) are defined as valid if ψ/η≤δ.

9. The computer-aided method as claimed in claim 8, wherein the threshold δ is between 0 and 0.1.

10. The computer-aided method as claimed in claim 1, further comprising accounting for constraints of the system parameters and/or constraints of the model function for validating the system parameters.

11. A method for operating an energy system in which the energy system is controlled at least in part by means of a closed-loop model-predictive control on the basis of a model function of a component of the energy system, the method comprising:
determining whether the system parameter of the model function on which the closed-loop model-predictive control is based is defined to be valid for the closed-loop control by:
calculating a standard deviation of the system parameters;
calculating a confidence bound based at least in part on the calculated standard deviation; and
defining the system parameters as valid if the ratio of confidence bound to the model function is less than or equal to a defined threshold within a value range defined for the input variable.

12. The method as claimed in claim 11, wherein the system parameters are ascertained from measurement data of the energy system.

13. The method as claimed in claim 12, wherein the measurement data are ascertained in automated fashion on the basis of captured measurement values.

14. The method as claimed in claim 13, wherein the measurement values are filtered for the purposes of ascertaining the measurement data.

15. An energy management system for an energy system, the energy management system comprising:
a measuring unit; and
a computing unit;
wherein the measuring unit captures a plurality of measurement values in respect of system parameters of the a component of the energy system and associated measurement data;
wherein the computing unit is programmed to:
calculating a standard deviation of the system parameters;
calculating a confidence bound based at least in part on the calculated standard deviation; and
defining the system parameters as valid if the ratio of confidence bound to the model function is less than or equal to a defined threshold within a value range defined for the input variable.
